(19) United States
(12) Patent Application Publication
(10) Pub. No.: US 2011/0132216 A1
(43) Pub. Date: Jun. 9, 2011

(54) STACK ANGLE COMPENSATION ARRANGEMENT FOR A SKEWING ADJUSTMENT SYSTEM IN AN OFFSET PRINTING PRESS

(75) Inventor: Marcel Motard, Laval (CA)

(73) Assignee: 7242514 CANADA INC., Ville St. Laurent (CA)

(21) Appl. No.: 12/964,315

(22) Filed: Dec. 9, 2010

Related U.S. Application Data
(60) Provisional application No. 61/267,982, filed on Dec. 9, 2009.

(51) Int. Cl. B41F 13/24; B41F 1/34

(52) U.S. Cl. 101/248; 101/485

(57) ABSTRACT

A stack angle compensation arrangement is disclosed. This arrangement is for use with a skewing adjustment system in an offset printing press unit that is configured and disposed for receiving plate and blanket cylinders of various diameters. The arrangement keeps the rotation axis of the skewing adjustment system in line with a reference plane, which reference plane is defined by the rotation axis of a plate cylinder (before skewing) and the rotation axis of a blanket cylinder, when the stack angle changes. A method of automatically compensating a change in the stack angle in an offset printing press unit having a skewing adjustment system is also presented.

### CROSS REFERENCE

The present case claims the benefit of U.S. patent application Ser. No. 11/267,982 filed 9 Dec. 2009, which is hereby incorporated by reference in its entirety.

### TECHNICAL FIELD

The technical field relates generally to offset printing presses, and more particularly to offset printing press units that are configured and disposed for receiving plate and blanket cylinders of various diameters.

### BACKGROUND

Offset printing is a printing lithographic technique where an inked image is transferred for “offset”) from a plate, acting as an image carrier, to a blanket and then to a printing substrate, for instance a paper web. In high-volume printing, the plate is in the form of a cylinder and the inked image is continuously transferred to a blanket cylinder. Both cylinders rotate in opposite direction and have a same tangential speed. The inked image on the blanket cylinder is transferred to the printing substrate. The printing substrate passes between the blanket cylinder and an impression cylinder. Generally, a high-volume printing press includes a plurality of juxtaposed printing units and the printing substrate runs through the printing units in order to receive the various colors of the image on one or both sides of the printing substrate.

Offset printing is based on the repulsion of ink and water. The plate cylinder receives ink coming from an ink unit. The ink adheres on the printing areas over the plate cylinder to form the image but does not adhere where a water-based film is present. This water-based film is created using a water solution coming from what is called the dampening unit. The water solution thus keeps the non-printing areas ink-free.

In use, each full rotation of the plate cylinder will print one copy of the image on the printing substrate. Each of these copies is called hereafter a “repeat”. The length of each repeat corresponds to the circumference of the plate cylinder. Thus, to change the length of the repeats, one must change the circumference of the plate cylinder. Since the blanket cylinder generally has a diameter that is substantially identical to the diameter of the plate cylinder or has a diameter that is substantially a multiple of the diameter of the plate cylinder, changing the diameter of the plate cylinder often requires changing the diameter of the blanket cylinder as well. Nevertheless, other configurations are also possible.

Whenever changing the diameters of the plate and blanket cylinders in a printing unit from a previous configuration, the relative distance between the rotation axes of the cylinders also changes. These rotation axes extend transversally within the side frame of the printing unit. The distance between the rotation axis of the plate cylinder and the rotation axis of the blanket cylinder is the smallest when using cylinders with the smallest possible diameters. The stack angle, which can be defined as the angle between the rotation axes with reference to the longitudinal direction of the printing unit, also changes when the diameters of the plate and the blanket cylinders change.

Various settings are often made by operators before or when the printing unit is running. For instance, an operator may need to slightly change the alignment of a printed image if it differs from the images printed on the substrate by the other printing units. This adjustment can be done by moving one end of the plate cylinder at one of the side frames. The adjustment is generally made on what is called “the operator side” of the printing unit and is referred to as “skewing”. Skewing is often made using a skewing adjustment system comprising an eccentric housing or a similar device. The eccentric housing repositions the corresponding end of the plate cylinder along an arcuate path. See for instance U.S. Pat. No. 5,272,974 to Guarino et al.

Initially, the width of the gap between the surface of the plate cylinder and the surface of the blanket cylinder is set to the desired value. The inventors have ascertained, however, in printing units where plate cylinders of various diameters can be used without the need of changing the skewing adjustment system, modifying the stack angle can inadvertently bring the surface of a plate cylinder closer to or away from the surface of a corresponding blanket cylinder during the skewing adjustment since the rotation axis of the eccentric housing will not be in line with the stack angle. Accordingly, room for improvements still exists in this area of technology.

### SUMMARY

There is provided a stack angle compensation arrangement for a skewing adjustment system in an offset printing press unit. When the stack angle changes, the arrangement automatically keeps the rotation axis of the skewing adjustment system in line with a reference plane, which reference plane is defined by the rotation axis of a plate cylinder (before skewing) and the rotation axis of a blanket cylinder. This arrangement can operate without the need of any intervention from an operator. There is also provided a method of automatically compensating a change in the stack angle in an offset printing press unit having a skewing adjustment system.

In one aspect, there is provided a stack angle compensation arrangement for a skewing adjustment system in an offset printing press unit having a plate cylinder and a blanket cylinder mounted for rotation around substantially parallel corresponding rotation axes, the stack angle compensation arrangement including: an eccentric housing positioned around the skewing adjustment system; and an actuator to rotate the eccentric housing when changing a stack angle of the offset printing press unit, the stack angle being defined by the end of the plate cylinder rotation axis and a corresponding end of the blanket cylinder rotation axis.

In another aspect, there is provided a method of automatically compensating a change in stack angle in an offset printing press unit having a skewing adjustment system, the method including: changing the stack angle of the offset printing press unit by replacing a first plate cylinder and a first blanket cylinder in the offset printing press unit with a second plate cylinder and a second blanket cylinder having a different diameter than that of the first plate cylinder and the first blanket cylinder; and automatically rotating the skewing adjustment system to compensate for the change of the stack angle.

Further details on these aspects as well as other aspects of the proposed concept will be apparent from the following detailed description and the appended figures.

### BRIEF DESCRIPTION OF THE FIGURES

FIG. 1 is a schematic view illustrating an example of a generic offset printing press unit;

FIGS. 2A and 2B are semi-schematic side views illustrating examples of two different sets of plate and blanket cylinders being mounted into a generic printing unit;

FIG. 3 is a schematic isometric view illustrating an example of a skewing adjustment;

FIG. 4 is a semi-schematic transversal view of the end of the plate cylinder and of the side frame on the operator side, showing an example of the relative position of the plate cylinder rotational axis with reference to the eccentric rotation axis of the skewing adjustment system;

FIG. 5 is a schematic side view illustrating an example of a skewing adjustment, as viewed from the operator side;

FIGS. 6A and 6B are schematic side views illustrating examples of positions of the first eccentric rotation axis and of the plate cylinder rotation axis before and after a change of the stack angle where no compensation is made;

FIGS. 7A and 7B are semi-schematic side views illustrate illustrating an example of an actuator in a stack angle compensation arrangement implementing the proposed concept;

FIGS. 5A and 8B are schematic side views illustrating an example of the positions of the first eccentric rotation axis and of the plate cylinder rotation axis before and after a change of the stack angle using the stack angle compensation arrangement implementing the proposed concept;

FIGS. 9A and 9B are semi-schematic transversal views of the end of the plate cylinder and of the side frame on the operator side, showing the engaged and the disengaged position of an example of a non-rotating trunnion that can be used with the stack angle compensation arrangement implementing the proposed concept;

FIGS. 10A and 10B are schematic side views illustrating an example of a throw-on/throw-off repositioning system, as viewed from the operator side, for use with the stack angle compensation arrangement implementing the proposed concept; and

FIG. 11 is a transversal cross-sectional view illustrating an example of the opposite ends of a plate cylinder arrangement.

### DETAILED DESCRIPTION

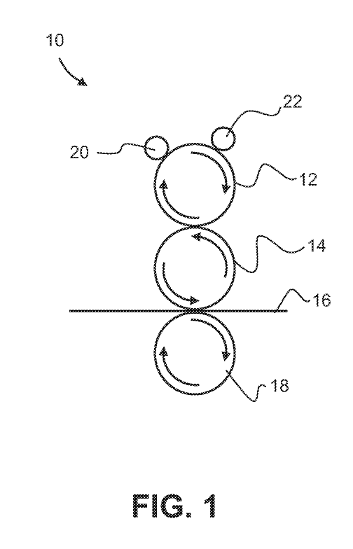

An example of a generic offset printing press unit 10 is schematically shown in FIG. 1. The illustrated generic printing unit 10 includes a plate cylinder 12, a blanket cylinder 14, a printing substrate 16 and an impression cylinder 18. A generic dampening roller 20 and a generic ink roller 22 are schematically illustrated in FIG. 1. It should be understood that in an actual printing unit, a dampening unit generally includes a plurality of rollers and other components. Likewise, an ink unit in an actual printing unit generally includes a plurality of rollers and other components.

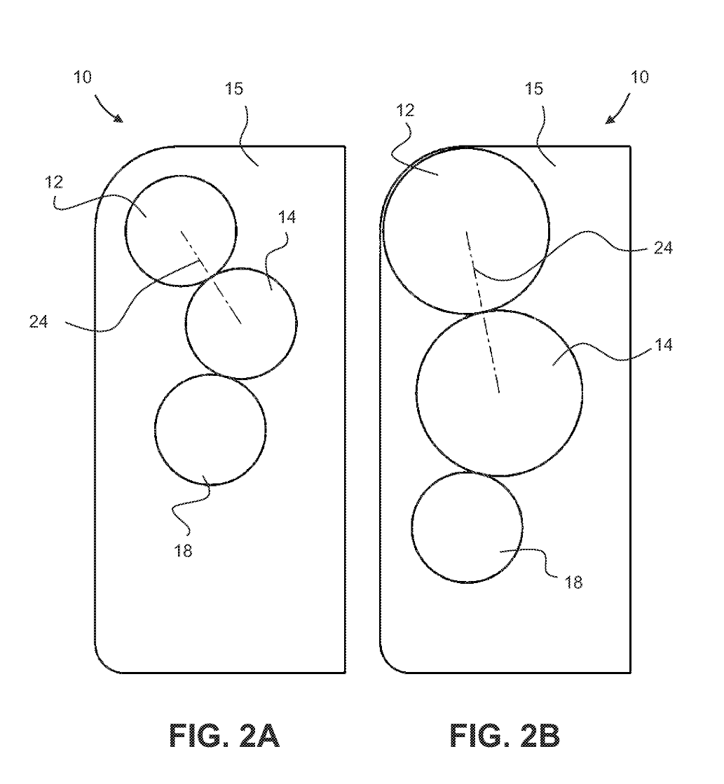

FIGS. 2A and 2B are semi-schematic side views illustrating examples of two different sets of plate and blanket cylinders 12, 14 being mounted into a generic printing unit 10 having a frame 15. FIG. 2A shows the cylinders 12, 14 having relatively small diameters while FIG. 2B shows the cylinders 12, 14 having relatively large diameters. The diameter of the impression cylinder 18 can remain the same in both cases, as shown in the example. FIGS. 2A and 2B further illustrate the variation of the stack angle when the diameters of the plate and blanket cylinders 12, 14 are changed. The reference plane defined by the rotation axis of the plate cylinder (before skewing) and the rotation axis of the blanket cylinder is shown at 24. This reference plane 24 corresponds to the stack angle.

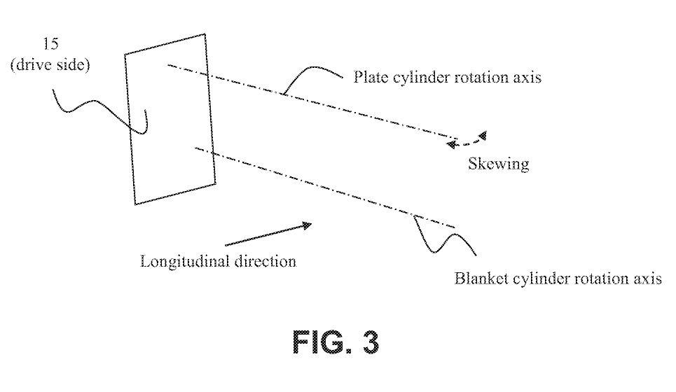

FIG. 3 is a schematic isometric view illustrating an example of an arcuate path followed by the end of the plate cylinder rotation axis during a skewing adjustment. The side of the frame opposite the operator side is “the drive side”.

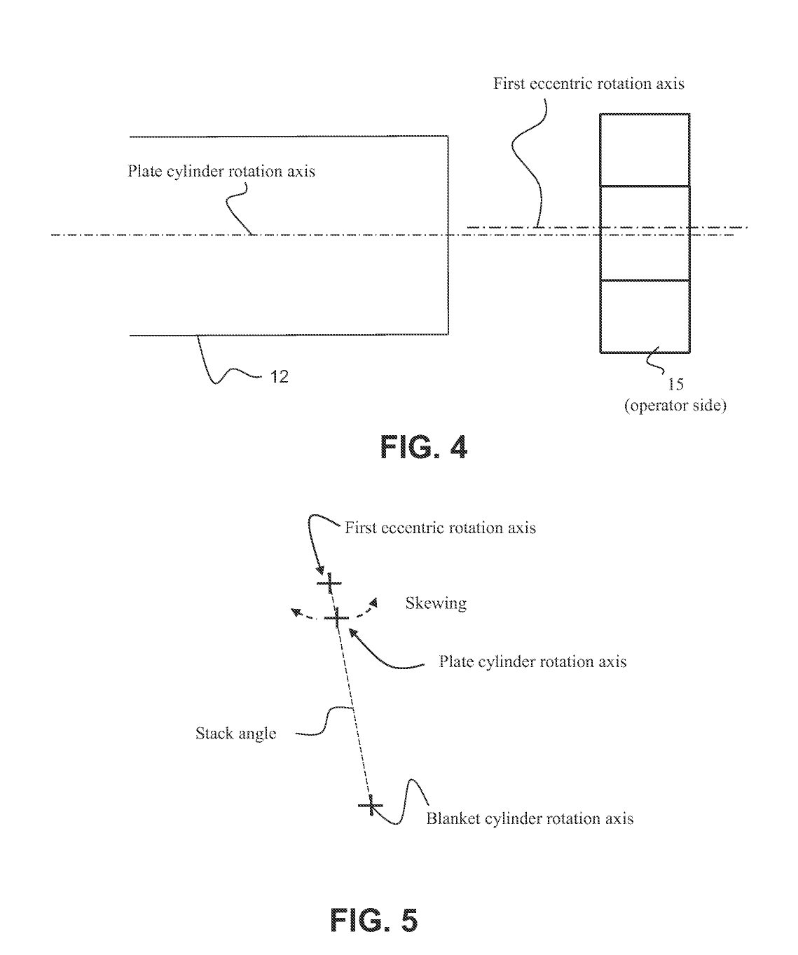

FIG. 4 is a semi-schematic transversal view of the end of the plate cylinder 12 and of the side frame on the operator side. This figure shows the relative position of the plate cylinder rotation axis with reference to the first eccentric rotation axis. It should be noted that the distances and proportions are exaggerated for the sake of clarity.

FIG. 5 schematically illustrates an example of a skewing adjustment, as viewed from the operator side.

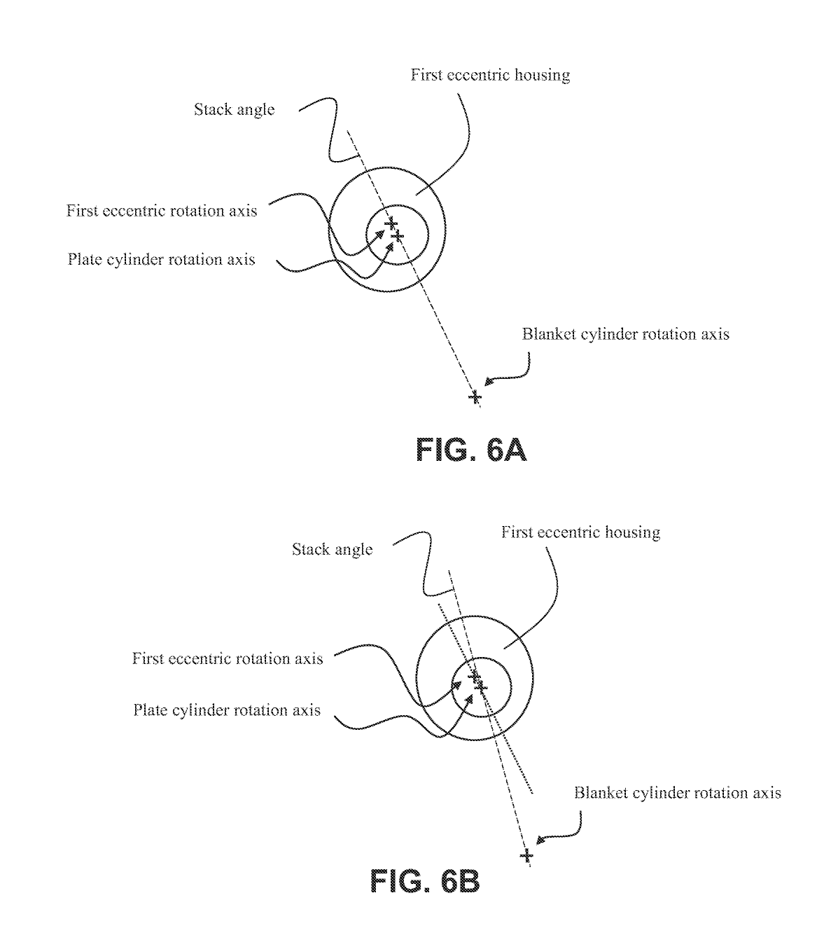

FIGS. 6A and 6B are schematic side views illustrating examples of positions of the first eccentric rotation axis and of the plate cylinder rotation axis before and after a change of the stack angle in the generic printing unit 10 shown in FIGS. 2A and 2B when no stack angle compensation arrangement is provided. FIG. 6A corresponds to the position of FIG. 2A and FIG. 6B corresponds to the position of FIG. 2B. As aforesaid, the stack angle changes when the diameter of the plate and blanket cylinders changes. FIG. 6B shows that without compensation, the end of the first eccentric rotation axis, at the operator side, is not in alignment with the stack angle. When an operator will skew using such setting, it can result in the plate cylinder surface being moved closer or away from the blanket cylinder surface. This is undesirable and ideally, the relative movement between them should be tangential. Although the eccentric housing of the skewing system does not move the end of the plate cylinder rotation axis in a perfectly straight tangential direction, the movement can be considered substantially tangential to some extent when the rotation axis of the eccentric housing is in-line with the stack angle. Thus, keeping the rotation axis of the first eccentric housing is in-line with the stack angle when using a new set of plate and blanket cylinders is highly desirable.

The present concept addresses this challenge by providing an arrangement capable of compensating for the change of the stack angle. When the stack angle changes, it keeps the rotation axis of the first eccentric housing in line with the reference plane, which reference plane is defined by the rotation axis of the plate cylinder (before skewing) and the rotation axis of the blanket cylinder. This arrangement can thus operate without any intervention from an operator.

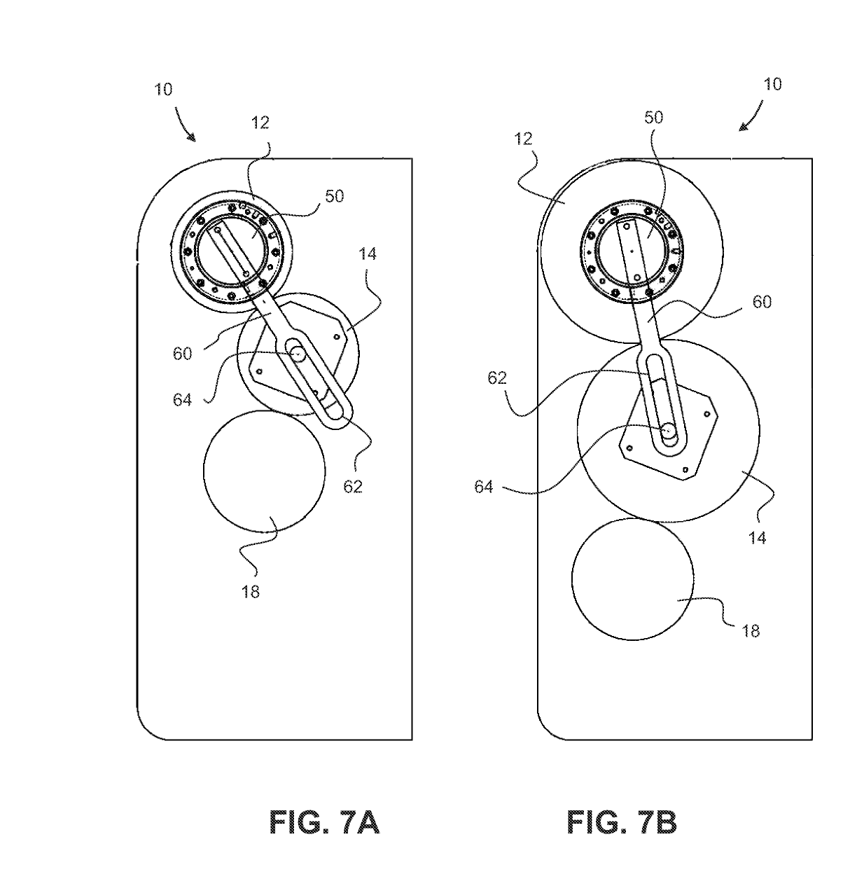

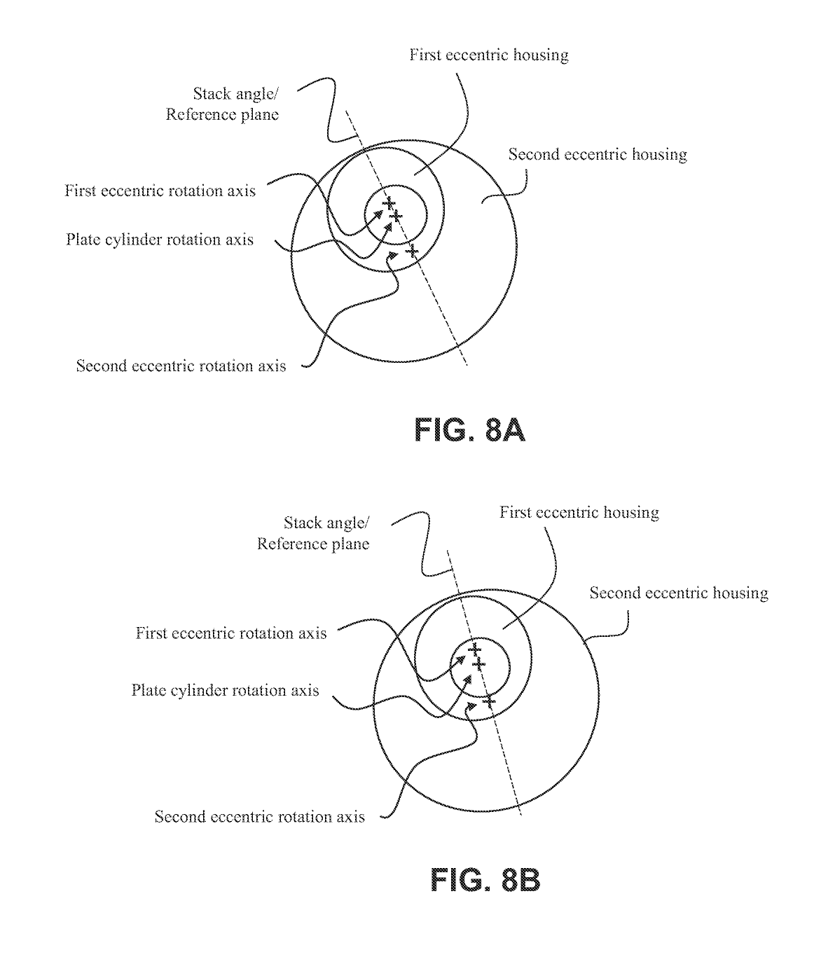

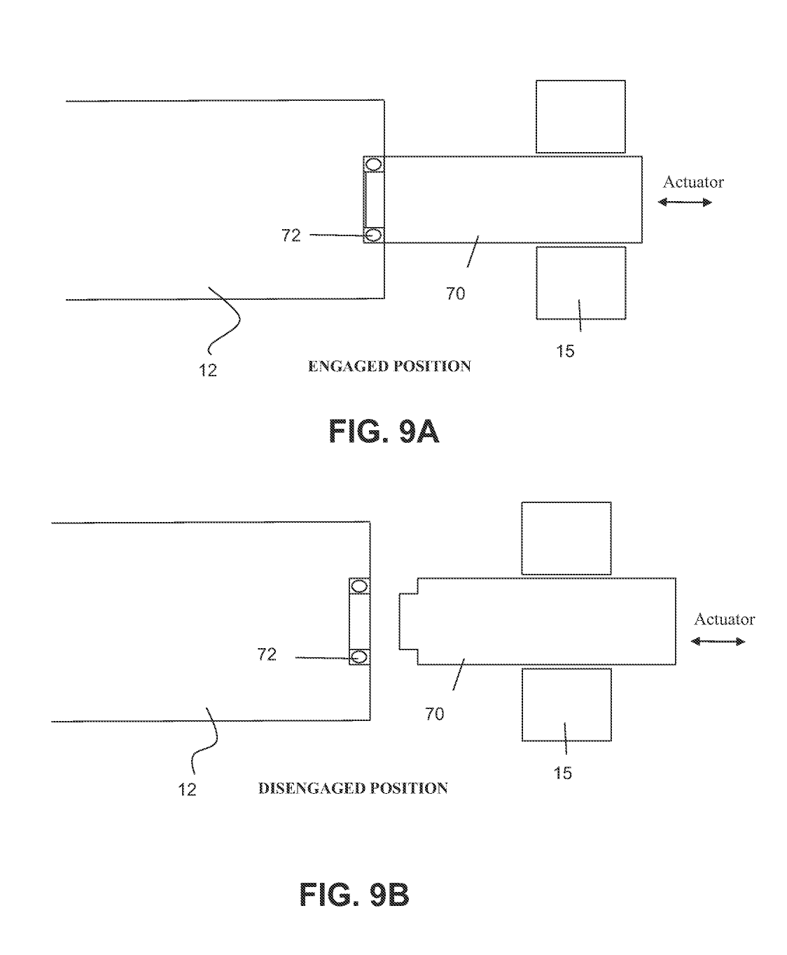

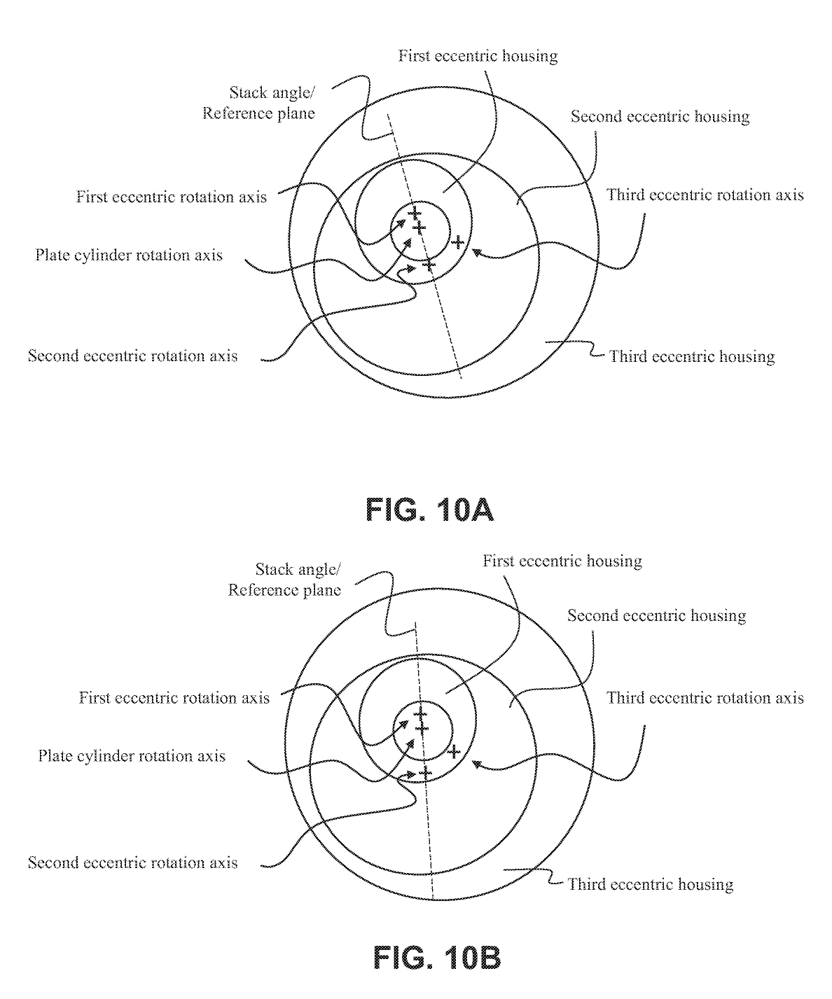

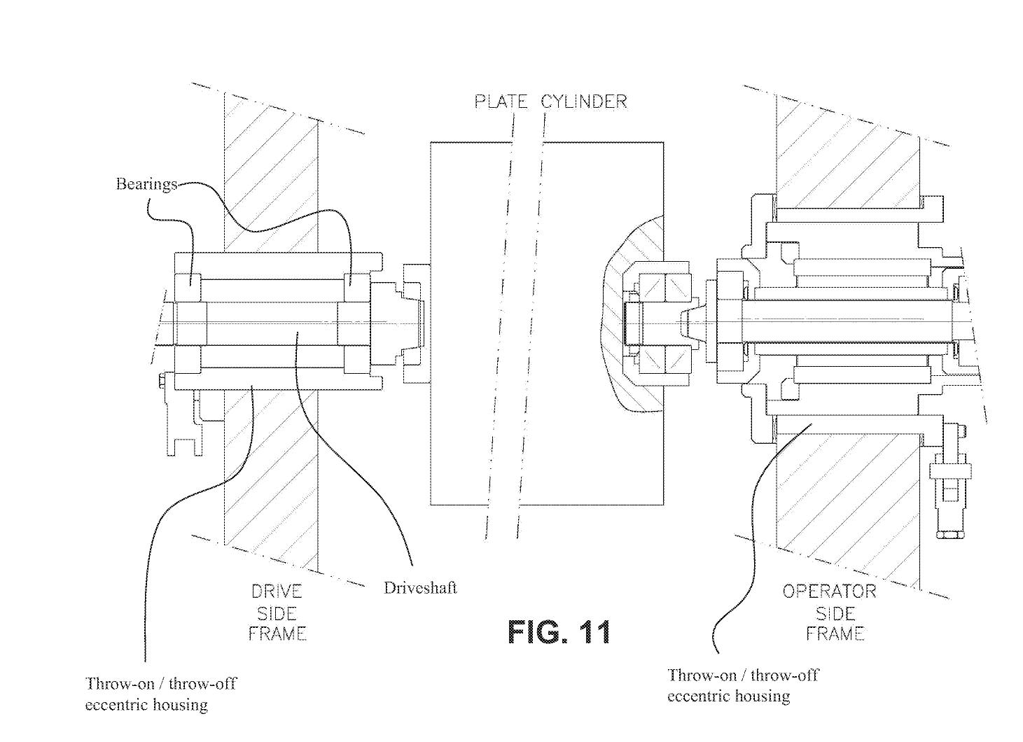

FIGS. 7A and 7B are semi-schematic side views illustrating an example of an actuator in a stack angle compensation arrangement implementing the proposed concept. This actuator is provided on the operator side to pivot the outer portion of a second eccentric housing 50 in which the first eccentric housing is located. In the illustrated example, the actuator includes a lever 60 rigidly connected at one end to the outer portion of the second eccentric housing 50. The lever 60 includes a longitudinal slot 62 near its other end. The interior of the slot 62 is operatively engaged by a follower 64 axially extending from a location on the side of the blanket cylinder 14. The axis of the follower 64 is in registry with the rotation axis of the blanket cylinder 14. The present concept encompasses other mechanisms for maintaining alignment of the first eccentric rotation axis with the stack angle reference plane, as will be understood by persons familiar with printing press technology in light of the present disclosure.

FIGS. 8A and 8B are schematic side views illustrating an example of the positions of the first eccentric rotation axis and of the plate cylinder rotation axis before and after a change of the stack angle using the stack angle compensation arrangement. FIG. 8A corresponds to the position of FIG. 7A and FIG. 8B corresponds to the position of FIG. 7B. The rotation between FIGS. 8A and 8B is around the second eccentric rotation axis. As can be appreciated, the first eccentric rotation axis and the plate cylinder rotation axis (before skewing) are now automatically, i.e. without manual or operator-controlled interaction, kept in line with the blanket cylinder rotation axis. Maintaining the position of the first eccentric rotation axis with the stack angle plane, or in two dimensions maintaining the first eccentric centerline with the line between the centers of the plate and blanket cylinders, prevents or diminishes the effect of inadvertently moving the surface of a plate cylinder closer to or away from the surface of a corresponding blanket cylinder during a skewing adjustment.

FIGS. 9A and 9B are semi-schematic transversal views of the end of the plate cylinder 12 and of the side frame 15 on the operator side, showing the engaged and the disengaged position of an example of a non-rotating trunnion 70 that can be used with the stack angle compensation arrangement. FIG. 9A illustrates that on the operator side, the plate cylinder 12 can be removably connected to the side frame 15 using the axially-movable trunnion 70. The trunnion 70 is mounted on and supported by the inner portion of the first eccentric housing, as will be understood by persons familiar with printing press technology and machines. The inside end of the trunnion 70 is removably engageable against the interior race of a bearing 72, such as an angular contact bearing, mounted within the axial boundaries on the side of the plate cylinder 12. In the example of FIGS. 9A and 9B, the trunnion 70 is not rotating with the plate cylinder 12, but rather may be rotationally fixed or may be rotatable (such as by hand) but rotationally isolated from the plate cylinder 12 by the bearing 72. FIG. 9B shows the trunnion 70 in the retracted disengaged position. The eccentric housings are not shown in FIGS. 9A and 9B for clarity.

It should be noted that the stack angle compensation arrangement can also be used in a printing unit that is not provided with a trunnion as shown in FIGS. 9A and 9B, or in a printing unit that is not provided with a trunnion but rather has a conventional shaft.

FIGS. 10A and 10B are schematic side views illustrating an example of a throw-on/throw-off repositioning system, as viewed from the operator side. This throw-on/throw-off repositioning arrangement is provided with two eccentric housings located on both sides of the frame of the printing unit. On the operator side, the first two eccentric housings are mounted inside the third (throw-on/throw-off eccentric housing. The third eccentric housings can be controlled by corresponding actuators. These actuators are activated to move the whole plate cylinder slightly away from the blanket cylinder, for instance when the printing unit stops or to mount a new image plate. See for instance U.S. Pat. No. 5,272,974 to Guarino et al.

It should be noted that the stack angle compensation arrangement can also be used in a printing unit having a different a throw-on/throw-off repositioning system from the one shown in FIGS. 10A and 10B, or in a printing unit that is not provided with a throw-on/throw-off repositioning system as shown in FIGS. 9A and 9B.

FIG. 11 is a transversal cross-section view illustrating an example of the opposite ends of a plate cylinder arrangement. The right portion of the figure somewhat corresponds to what is illustrated in FIG. 9B. Further, the left portion of FIG. 11 shows the plate cylinder being engaged on the drive side frame. The plate cylinder is in a torque-transmitting engagement with the inner end of a driveshaft. The driveshaft is supported by two spaced-apart bearings mounted inside the throw-on/throw-off eccentric housing. Other arrangements are also possible.

The present detailed description and the appended figures are meant to be exemplary only, and a skilled person will recognize that variants can be made in light of a review of the present disclosure without departing from the proposed concept.

What is claimed is:

1. A stack angle compensation arrangement for a skewing adjustment system in an offset printing press unit having a plate cylinder and a blanket cylinder mounted for rotation around substantially parallel corresponding rotation axes, the stack angle compensation arrangement including:
an eccentric housing positioned around the skewing adjustment system; and
an actuator to rotate the eccentric housing when changing a stack angle of the offset printing press unit, the stack angle being defined by the end of the plate cylinder rotation axis and a corresponding end of the blanket cylinder rotation axis.

2. The stack angle compensation arrangement as defined in claim 1, in which the skewing adjustment system is provided at the end of the plate cylinder rotation axis, wherein the actuator mechanically links an outer portion of the eccentric housing and a follower that is coaxial with the blanket cylinder rotation axis.

3. The stack angle compensation arrangement as defined in claim 2, wherein the actuator includes an elongated lever, the lever being rigidly connected to the outer portion of the eccentric housing and being slidably connected to the follower.

4. The stack angle compensation arrangement as defined in claim 3, wherein the lever includes a longitudinal slot to which the follower is operatively engaged, the lever being configured and disposed to rotate the eccentric housing so as to keep a rotation axis of the skewing adjustment system in registry with the stack angle when the stack angle changes.

5. The stack angle compensation arrangement as defined in claim 4, wherein the lever and its longitudinal slot are rectilinear.

6. The stack angle compensation arrangement as defined in claim 1, in which the skewing adjustment system is provided at the end of the plate cylinder rotation axis, wherein the skewing adjustment system includes an eccentric housing having a rotation axis, the actuator including means for keeping a rotation axis of the skewing adjustment system in registry with the stack angle when changing at least one among the plate cylinder and the blanket cylinder in diameter.

7. The stack angle compensation arrangement as defined in claim 6, in which the plate cylinder and the blanket cylinder are substantially identical in diameter, wherein the means for keeping the rotation axis of the skewing adjustment system in registry with the stack angle include a self-adjusting mechanism, an outer portion of the eccentric housing of the stack angle compensation arrangement having a variable angular position relative to the eccentric housing of the skewing adjustment system, the relative angular position depending on the diameter of the plate cylinder and the blanket cylinder.

8. The stack angle compensation arrangement as defined in claim 7, wherein the self-adjusting mechanism includes a mechanical link between the outer portion of the eccentric housing of the stack angle compensation arrangement and a location in registry with the end of the blanket cylinder rotation axis.

9. The stack angle compensation arrangement as defined in claim 1, wherein the skewing adjustment system is removably connected to the plate cylinder by an axially-movable trunnion, the trunnion being rotationally isolated from the plate cylinder using a bearing mounted on a side of the plate cylinder.

10. The stack angle compensation arrangement as defined in claim 1 further including a throw-on/throw-off eccentric housing positioned between the eccentric housing of the stack angle compensation arrangement and a side frame of the offset printing press unit.

11. A method of automatically compensating a change in stack angle in an offset printing press unit having a skewing adjustment system, the method including:
changing the stack angle of the offset printing press unit by replacing a first plate cylinder and a first blanket cylinder in the offset printing press unit with a second plate cylinder and a second blanket cylinder having a different diameter than that of the first plate cylinder and the first blanket cylinder; and
automatically rotating the skewing adjustment system to compensate for the change of the stack angle.

12. The method as defined in claim 11, wherein the automatic rotation of the skewing adjustment system is proportional to the change in the stack angle.

13. The method as defined in claim 12, wherein the automatic rotation is achieved using a mechanical link provided between the skewing adjustment system and a location in registry with a rotation axis of the blanket cylinder.

14. The method as defined in claim 13, wherein the mechanical link includes a sliding engagement provided between a lever and the location in registry with the rotation axis of the blanket cylinder.

15. The method as defined in claim 14, wherein the mechanical link includes a rigid connection provided between the lever and the skewing adjustment system.

16. The method as defined in claim 11, wherein changing the stack angle of the offset printing press unit includes disengaging an axially-movable trunnion mounted inside the skewing adjustment system from a side of the first plate cylinder, and engaging the axially-movable trunnion to a side of the second plate cylinder.

17. The method as defined in claim 11, further including subsequently subjecting the second plate cylinder to a throw-in/throw-off movement.

18. The method as defined in claim 11, wherein automatically rotating the skewing adjustment system to compensate for the change of the stack angle includes keeping a rotation axis of the skewing adjustment system in registry with the stack angle.

19. The method as defined in claim 11, wherein automatically rotating the skewing adjustment system to compensate for the change of the stack angle includes rotating an outer portion of an eccentric housing inside which the skewing adjustment system is mounted.

20. The method as defined in claim 19, wherein the skewing adjustment system is rotated from an operator side of the offset printing press unit.
